(19) United States
(12) Patent Application Publication
(10) Pub. No.: US 2026/0038257 A1
(43) Pub. Date: Feb. 5, 2026

(54) TIME-LAPSE IMAGE CLASSIFICATION USING A DIFFRACTIVE NEURAL NETWORK

(71) Applicant: THE REGENTS OF THE UNIVERSITY OF CALIFORNIA, Oakland, CA (US)

(72) Inventors: Aydogan Ozcan, Los Angeles, CA (US); Md Sadman Sakib Rahman, Irvine, CA (US)

(73) Assignee: THE REGENTS OF THE UNIVERSITY OF CALIFORNIA, Oakland, CA (US)

(21) Appl. No.: 19/099,751

(22) PCT Filed: Aug. 9, 2023
(86) PCT No.: PCT/US2023/071949

§ 371 Date: Jan. 29, 2025

Related U.S. Application Data
(60) Provisional application No. 63/373,162, filed on Aug. 22, 2022.

(51) Int. Cl. G06V 10/88; G06N 3/067; G06V 10/764; G06V 10/82

(52) U.S. Cl. CPC G06V 10/88; G06N 3/067; G06V 10/764; G06V 10/82

(57) ABSTRACT

A time-lapse image classification device and method is disclosed that uses a diffractive optical network to classify an optical input, significantly advancing classification accuracy and generalization performance on complex input objects by using the lateral movements of the input objects and/or the diffractive optical network relative to each other. The design space and performance limits of time-lapse diffractive optical networks were numerically tested, revealing a blind testing accuracy of 62.03% on the optical classification of objects from the CIFAR-10 dataset. This constitutes the highest inference accuracy achieved so far using a single diffractive optical network on the CIFAR-10 dataset. Time-lapse diffractive optical networks will be broadly useful for the spatio-temporal analysis of input signals using all-optical processors.

### RELATED APPLICATION

This application claims priority to U.S. Provisional Patent Application No. 63/373,162 filed on Aug. 22, 2022, which is hereby incorporated by reference. Priority is claimed pursuant to 35 U.S.C. § 119 and any other applicable statute.

### STATEMENT REGARDING FEDERALLY SPONSORED RESEARCH AND DEVELOPMENT

This invention was made with government support under DE-SC0023088 awarded by the U.S. Department of Energy. The government has certain rights in the invention.

### TECHNICAL FIELD

The technical field generally relates to optical-based deep learning physical architectures or platforms that can perform various complex functions and tasks that current computer-based neural networks can implement. The optical deep learning physical architecture or platform has applications in image classification and reconstruction. In particular, the technical field relates to such optical-based architectures and platforms that perform time-lapse image classification using the movement of the input objects and/or the diffractive network, relative to each other.

### BACKGROUND

Machine learning and artificial intelligence research has experienced rapid growth in the past two decades. One of the core engines that has driven this growth is deep learning, permitting efficient and rapid training of deep artificial neural network models. The ability to train deep neural networks has revolutionized artificial intelligence, and electronics has been the undisputed platform of choice for implementing artificial neural networks. Specialized processing hardware such as Graphics Processing Units (GPUs) are widely used today for deep learning. However, these electronic processors are expensive, power-hungry, and bulky, making researchers wary of the environmental impact of machine learning. Therefore, there is strong interest in low-power and fast computing platforms for machine learning applications. Optical computing has been identified as a promising potential alternative for such purposes because of the large bandwidth, high speed, and massive parallelism of optics.

Diffractive deep neural networks (D²NNs), also known as diffractive optical networks or diffractive networks, form a passive all-optical computing platform that exploits the diffraction of light waves to perform computations. These diffractive networks are composed of several spatially-engineered surfaces, separated by free-space. The diffractive features/elements of a layer, also termed ‘diffractive neurons’, locally modulate the amplitude and/or the phase of the light incident upon the layer. Successive modulation by and diffraction through the layers give rise to an all-optical transformation between the input and the output fields-of-view at the speed of light propagation without any external power. The amplitude and/or the phase values of the diffractive neurons corresponding to a desired optical transformation or computational task are trained/learned through a digital computer using deep learning. Once the training is complete, the layers can be fabricated and assembled to form a ‘physical’ network that performs the desired computation in a passive manner and at the speed of light propagation. Diffractive networks can achieve universal linear transformations, and various applications using diffractive processors have been demonstrated such as object classification, pulse processing, imaging through random diffusers, hologram reconstruction, quantitative phase imaging, class-specific imaging, super-resolution image display, all-optical logic operations, beam shaping and orbital angular momentum mode processing, among others.

While diffractive networks have shown competitive performance on the classification of relatively simpler objects, for example, hand-written digits and fashion products, for more complex natural objects such as those from the CIFAR-10 dataset, their performance gap compared to the classification accuracy of electronic neural networks is still large. Ensemble learning through multiple D²NNs has been demonstrated to improve the inference and generalization of diffractive networks at the cost of reducing the compactness and simplicity of the optical hardware. There is a need for improved diffractive optical networks that provide competitive performance on more complex natural objects.

### SUMMARY

A diffractive optical network is disclosed that performs ‘time-lapse’ image classification that significantly enhances the inference and generalization performance of diffractive computing. In this system or platform, the objects and/or the diffractive optical network laterally move relative to each other, either randomly or in a controlled manner, during the detector integration time, enriching the information provided to the diffractive network. The controlled or random relative displacements between the input objects and the diffractive network was used for time-lapse image classification and a numerical blind testing accuracy of 62.03% was achieved for the classification of grayscale CIFAR-10 images, which constitutes the highest classification accuracy for this dataset achieved so far using a single diffractive optical network. In addition to significantly advancing the inference and generalization performance of D²NNs, these time-lapse diffractive optical networks can also find broader use in the all-optical processing of spatio-temporal information of a scene or object.

In one embodiment, a diffractive optical network for classifying time-lapse input images, input optical signals, or input optical data includes a plurality of optically transmissive and/or reflective layers arranged in one or more optical paths, each of the plurality of optically transmissive and/or reflective layers comprising a plurality of physical features located in different locations in each of the one or more layers of the network and having different valued transmission and/or reflection parameters as a function of lateral coordinates across each layer, wherein the plurality of optically transmissive and/or reflective layers and the plurality of physical features collectively generate different optical outputs at an output plane for different classes of input images, input optical signals, or input optical data; and a plurality of optical detectors disposed along the one or more optical paths and located at the output plane and positioned to capture the different optical outputs of the diffractive optical network; and wherein relative movement between the (1) input images, input optical signals, or input optical data and the (2) diffractive optical network generates a time-lapse optical output at the output plane that is captured by the plurality of optical detectors and is used to classify the input images, input optical signals, or input optical data.

In another embodiment, a method of classifying time-lapse input images, input optical signals, or input optical data includes providing a diffractive optical network, the diffractive optical network including a plurality of optically transmissive and/or reflective layers arranged in one or more optical paths, each of the plurality of optically transmissive and/or reflective layers comprising a plurality of physical features located in different locations in each of the one or more layers of the network and having different valued transmission and/or reflection parameters as a function of lateral coordinates across each layer, the plurality of physical features being fabricated following a trained electronic model of the diffractive optical network, wherein the plurality of optically transmissive and/or reflective layers and the plurality of physical features collectively generate different optical outputs at an output plane for different classes of input images, input optical signals, or input optical data; and a plurality of optical detectors disposed along the one or more optical paths and located at the output plane and positioned to capture the different optical outputs of the diffractive optical network. The method further includes inputting the input images, input optical signals, or input optical data to the diffractive optical network while there is relative movement between the (1) input images, input optical signals, or input optical data and the (2) diffractive optical network and generating a time-lapse optical output at the output plane that is captured by the plurality of optical detectors and is used to classify the input images, input optical signals, or input optical data.

In some embodiments, one or more layers of the diffractive optical network may include reconfigurable features such as, for example, spatial light modulators.

### BRIEF DESCRIPTION OF THE DRAWINGS

FIG. 1 illustrates an embodiment of the diffractive optical network for classifying an optical input such as time-lapsed images, optical signals, or optical data. Here, the input is an input image of a ship that is classified by the diffractive optical network.

FIG. 2 illustrates a flowchart of the operations or processes according to one embodiment to create and use a diffractive optical network for classifying time-lapsed images, optical signals, or optical data. A computing device is also illustrated that is used to digitally train the model of the diffractive optical network prior to manufacturing the physical embodiment.

FIG. 3 illustrates an example of a layer used in the diffractive optical network.

FIG. 4A illustrates a diffractive network with five (5) phase-only diffractive layers followed by twenty (20) optical detectors at the detector/output plane for differential image classification. The integration time of each detector is Not. During each one of the N intervals of δₜ duration, the center of the object is laterally displaced to a new point. The lateral displacements can be entirely random or follow a predefined grid (e.g., dots in FIG. 4A).

FIG. 4B illustrates labeling of the optical detectors where D_{c,+} (D_{c,-}) denote the positive (negative) detectors assigned to class c. The differential class-scores z, are used for the final classification decision based on the maximum score. Equations for differential classification appear alongside the optical detectors.

FIG. 5A illustrates a graph showing the dependence of the blind testing accuracy on sₘₐₓ with m and the input aperture kept constant.

FIG. 5B illustrates a graph showing the effect of m on the blind testing accuracy of the trained time-lapse diffractive classifiers as sₘₐₓ and the input aperture are kept constant.

FIG. 5C illustrates a graph showing the dependence of the blind testing accuracy on the input aperture size while sₘₐₓ and m are kept constant. For FIGS. 5A-5C, the data points and the error bars represent the mean and the standard deviation values, respectively, calculated from three designs, which are obtained by training three different time-lapse diffractive optical network classifiers for the same set of hyperparameter values. The curves are linearly interpolated between the data points.

FIG. 5D illustrates a grid of points (left) representing the lateral displacements of the input objects during the training, defined by the two hyperparameters, sₘₐₓ and m. sₘₐₓ represents the maximum displacement along either the vertical or the horizontal direction, whereas m² is the total number of grid points. FIG. 5D (right) illustrates a dashed white square that represents the input aperture immediately following the object, the area of which is another hyperparameter.

FIGS. 6A-6C illustrate the comparison between a time-static and a time-lapse diffractive image classifier. FIG. 6A illustrates the detector plane intensity, detector signals, and class scores from the time-static network for an object (a ship) from the data class 8 of the CIFAR-10 dataset. Based on the class scores, the object is misclassified to be an automobile. FIG. 6B illustrates the integrated detector plane intensity, detector signals, and class scores from the time-lapse diffractive network for the same object, which is correctly classified as a ship. FIG. 6C illustrates the confusion matrices for the two networks (static and time-lapse), evaluated by blind testing on 10000 CIFAR-10 test images. The overall accuracies of the networks are 53.14% and 62.03%, respectively. The training parameters of these two networks are shown in FIGS. 9A-9C.

FIGS. 7A-7C illustrates the impact of the lateral shifts on network performance. FIG. 7A shows the impact of decreasing the number of lateral shifts (N) on the blind testing accuracy while confining the input object displacements to the training grid points: the time-lapse D²NNs were trained with different p values. Diffractive networks trained with lower p values are less affected by a decrease in N. FIG. 7B shows the impact of random off-grid lateral displacements of input objects during the blind testing of time-lapse diffractive networks trained with displacements confined to a predefined grid. Time-lapse diffractive classifiers trained with lower p values are more resilient to such deviation from the training settings. FIG. 7C illustrates the improvement of blind testing accuracies for a given N, by training the time-lapse diffractive network with Nₜᵣ=N arbitrary/random displacements within the range 2sₘₐₓ×2sₘₐₓ instead of training with a set of fixed lateral displacements defined by a pre-determined lateral grid. For FIGS. 7A-7C, the values (errors) corresponding to the data points represent the mean (standard deviation) values calculated through the blind testing of the same trained network 25 times, every time with N arbitrary lateral displacements of the input objects.

FIGS. 8A-8B illustrate the performance of a time-lapse diffractive network without trainable detector exponents (i.e., γ_{c,±}=1). FIG. 8A shows the integrated detector plane intensity, detector signals, and class scores from the network for an input object (a cat) from data class 3 of the CIFAR-10 dataset. Based on the class scores, the object is correctly classified. FIG. 8B shows the confusion matrix for the network, evaluated by blind testing on 10000 images from the CIFAR-10 test set. The overall accuracy of the network on CIFAR-10 test set is 60.35%. The phase profiles of the trained diffractive layers of this network are shown in FIG. 9C.

FIG. 9A illustrates the trained diffractive layer phase values for the time-static D²NN of FIG. 6A.

FIG. 9B illustrates the trained diffractive layer phase values and detector exponents for the time-lapse D²NN of FIG. 6B.

FIG. 9C illustrates the trained diffractive layer phase values for the time-lapse D²NN of FIGS. 8A-8B, for which the detector exponents were not trainable (i.e., γ_{c,±}=1).

### DETAILED DESCRIPTION OF ILLUSTRATED EMBODIMENTS

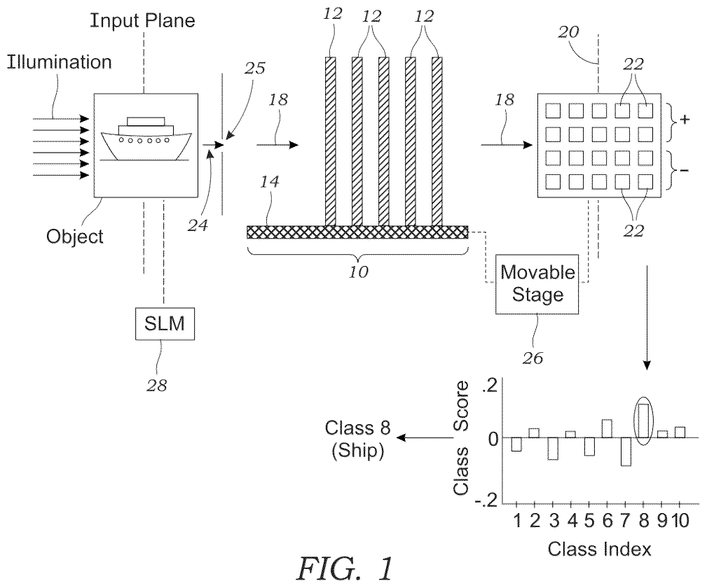

With reference to FIGS. 1, 3 and 4A, the diffractive optical network 10 (also referred to diffractive networks or D²NNs) include one or more diffractive layers 12. When a plurality of such diffractive layers 12 are used, they are spaced apart from one another. The spacing between adjacent diffractive layers 12 may be maintained by using a holder or housing 14 that fixes the distance(s) between the diffractive layers 12. In one embodiment, the one or more diffractive layers 12 are transmissive to light whereby light diffracts as it passes through the various diffractive layer(s) 12 and interacts with physical features 16 formed on or in the diffractive layer(s) 12 contained therein (FIG. 3).

The physical features 16 formed on or in the diffractive layer(s) 12 thus create a pattern of physical locations within the diffractive layer(s) 12 that have different transmission properties as a function of local coordinates (e.g., length and width and in some embodiments depth) across each diffractive layer 12. In some embodiments, each separate physical feature 16 may define a discrete region with a particular transmissive property or attribute on the diffraction layer 12 while in other embodiments, multiple physical features 16 may combine or collectively define a physical region with a particular transmission property or attribute. These physical features 20 form the physical “neurons” in the layers 12 that make up the diffractive optical network 10.

In other embodiments, the diffractive layer(s) 12 may include reflective layer(s) 12 where light reflects of the surface(s) thereof. As noted, each diffractive layer 12 of the diffractive optical network 10 has a plurality of physical features 16 formed on the surface of the layer 12 or within the layer 12 itself that individually or collectively define a pattern of physical locations along the length and width of each layer 12 that have varied transmission parameters/attributes (or varied reflection parameters/attributes for reflective layers 12).

The one or more layers 12 are arranged along an optical path 18 as seen in FIG. 1 or multiple optical paths 18. The one or more layers 12 are configured to receive an optical input 24. The optical input 24 may include input optical images (i.e., an image of an object like illustrated in FIG. 1), input optical signals, or input optical data. The one or more layers 12 either individually or collectively generate different optical outputs at an output plane 20 that includes, in one embodiment, a plurality of optical detectors 22. In this embodiment, different optical detectors 22 of the plurality collect optical signals that correspond to the different classes of the optical input 24 input to the diffractive optical network 10, namely, the input optical images, input optical signals, or input optical data. Each class may be associated with a single optical detector 22 or a sub-group of the plurality of optical detectors 22. Based the class of optical input 24, different optical outputs are generated at the output plane 20. This includes, for example, different light intensities at different locations on the output plane 20 (e.g., lateral positions on the output plane 20). These different light intensity signals are captured by the plurality of optical detectors 22. The optical detectors 22 may include single-pixel detectors. The optical detectors 22 may also include an array of detectors or an imaging chip (e.g., CMOS) that captures or reveals images on pixels (e.g., focal plane array). In this embodiment, the different pixels or pixel groupings of the imaging chip may capture the different optical outputs.

In some embodiments (e.g., differential embodiments), the plurality of optical detectors 22 may include pairs of detectors 22 which each data class having a corresponding pair of detectors 22 which are configured to capture virtually positive and negative output signals. Each data class is represented by a pair of detectors 22 (or other groupings) at the output plane 20, where the normalized difference between these detector pairs represents the class scores. In the differential embodiment, the pairs of detectors 22 may be coupled to circuitry that are used to perform a differential operation on groups of optical detectors 22. In particular, in one implementation, a group of optical detectors 22 is formed by a pair of optical detectors 22 with one of the optical detectors 22 being classified as a virtually “positive” detector and the other optical detector 22 being classified as a virtually “negative” detector. A positive optical detector 22 is a detector whose output (e.g., output signal or data) is added to another optical signal or data with a positive scaling factor or coefficient. A negative optical detector 22 is a detector whose output (e.g., output signal or data) is added to another optical signal or data with a negative scaling factor or coefficient.

A differential amplifier circuit may be used to generate an output that is the signal difference between the inputs from the negative optical detector 22 and the positive optical detector 22 within a particular group. Each group of optical detectors 22 may include its own circuitry or hardware (or share common circuitry or hardware with time multiplexing of inputs) that is used to calculate the signal difference within the negative optical detector(s) 22 and positive optical detector(s) 22 making up the group (e.g., pair). An example of differential detection may be found in International Patent Publication No. WO 2020/247828, which is incorporated by reference herein.

With reference to FIG. 3, the pattern of physical locations formed by the physical features 16 may define, in some embodiments, an array located across the surface of the diffractive layer(s) 12. The diffractive layer 12, in one embodiment, is a two-dimensional generally planer substrate having a length (L), width (W), and thickness (t) that all may vary depending on the particular application. In other embodiments, the diffractive layer 12 may be non-planer. The local coordinates of the physical features 16 and/or the physical regions formed thereby act as artificial “neurons” within the diffractive layer(s) 12 that connect to other “neurons” of other diffractive layer(s) 12 of the diffractive optical network 10 and alter the phase and/or amplitude of the light wave passing therethrough or reflecting therefrom. The particular number and density of the physical features 16 or artificial neurons that are formed in each diffractive layer 12 may vary depending on the type of application. In some embodiments, the total number of artificial neurons may only need to be in the hundreds or thousands while in other embodiments, hundreds of thousands or millions of neurons or more may be used.

Likewise, the number of diffractive layers 12 that are used in a particular diffractive optical network 10 may vary although it typically ranges from at least one diffractive layer 12 to less than ten diffractive layers 12 (although additional diffractive layers 12 beyond this range are contemplated). As described herein, in one embodiment, the various neurons are formed by differing the thickness of diffractive layer(s) 12 across the surface thereof. In one embodiment, the different thicknesses (t) modulate the phase of the light passing through the diffractive layer 12 (FIG. 3). This type of physical feature 20 may be used, for instance, in the transmission mode embodiment. The different thicknesses of material in the diffractive layer 12 forms a plurality of discrete “peaks” and “valleys” that control the transmission properties of the neurons formed in the diffractive layer 12. The different thicknesses of the diffractive layer 12 may be formed using additive manufacturing techniques (e.g., 3D printing) or lithographic methods utilized in semiconductor processing. This includes well-known wet and dry etching processes that can form very small lithographic features on a substrate. Lithographic methods may be used to form very small and dense physical features 16 on or within the diffractive layer 12 which may be used with shorter wavelengths of the light.

Alternatively, the transmission function of a neuron can also be engineered by using metamaterial or plasmonic structures. Combinations of all these techniques may also be used. In other embodiments, non-passive components may be incorporated in into the substrates such as spatial light modulators (SLMs). SLMs are devices that imposes spatial varying modulation of the phase, amplitude, or polarization of a light. One or more of these SLMs may be incorporated in the layer(s) 12. SLMs may include optically addressed SLMs and electrically addressed SLM. Electric SLMs include liquid crystal-based technologies that are switched by using thin-film transistors (for transmission applications) or silicon backplanes (for reflective applications). Another example of an electric SLM includes magneto-optic devices that use pixelated crystals of aluminum garnet switched by an array of magnetic coils using the magneto-optical effect. Additional electronic SLMs include devices that use nanofabricated deformable or moveable mirrors that are electrostatically controlled to selectively deflect light. Thus, in some embodiments, the physical properties of the layers 16 may be adjusted or tuned as a function of time.

The particular spacing of the diffractive layers 12 that make the diffractive optical network 10 may be maintained using a holder or housing 14 like that illustrated in FIG. 1. The holder or housing 14 may contact one or more peripheral surfaces of the diffractive layers 12. In some embodiments, the holder or housing 14 may contain a number of slots that provide the ability of the user to adjust the spacing between adjacent diffractive layers 12. A single holder or housing 14 can thus be used to hold different diffractive optical networks 10. In some embodiments, the diffractive layers 12 may be permanently secured to the holder or housing 14 while in other embodiments, the diffractive layers 12 may be removable from the holder or housing 14 and replaceable. For example, on or more layers 12 may be removed/added to the holder or housing 14 to create different diffractive optical networks 10 or to tune/alter the performance of the diffractive optical network 10. The holder or housing 14 may be incorporated into another device such within a housing of a camera or other imaging device.

With reference to FIG. 1, during operation of the diffractive optical network 10, relative movement is introduced between the (1) optical input 24, for example, the input images, input optical signals, or input optical data and the (2) diffractive optical network 10. This relative movement may include two-dimensional (2D) or three-dimensional (3D) relative movement. As one example, this may include lateral movement which is generally orthogonal to the optical path 18 through the diffractive optical network 10. The movement may be random or controlled. This movement may be introduced digitally to the input images, input optical signals, or input optical data using Spatial Light Modulators (SLMs) 28 (such as illustrated in FIG. 1) to cause lateral displacements. Alternatively, the diffractive layers 12 and optical detectors 22 may be mounted on or mechanically coupled to a moveable stage 26 that can shift the diffractive optical network 10 relative to the optical input 24 (e.g., input images, input optical signals, or input optical data). In yet another alternative, the movement is produced by the natural jitter or movement of the optical input 24 (e.g., input images, input optical signals, or input optical data) during the integration time of the optical detectors 22. The integration time of the optical detectors 22 is the period of time that the optical detectors 22 detect or capture illumination from the diffractive layers 12. As noted herein, a time-lapse optical output at the output plane 20 is captured by the plurality of optical detectors 22 and is used to classify the optical input 24, namely the input images, input optical signals, or input optical data. The time scale of the time-lapse optical output that is captured by the optical detectors 22 may vary but is typically ≤10 sec.

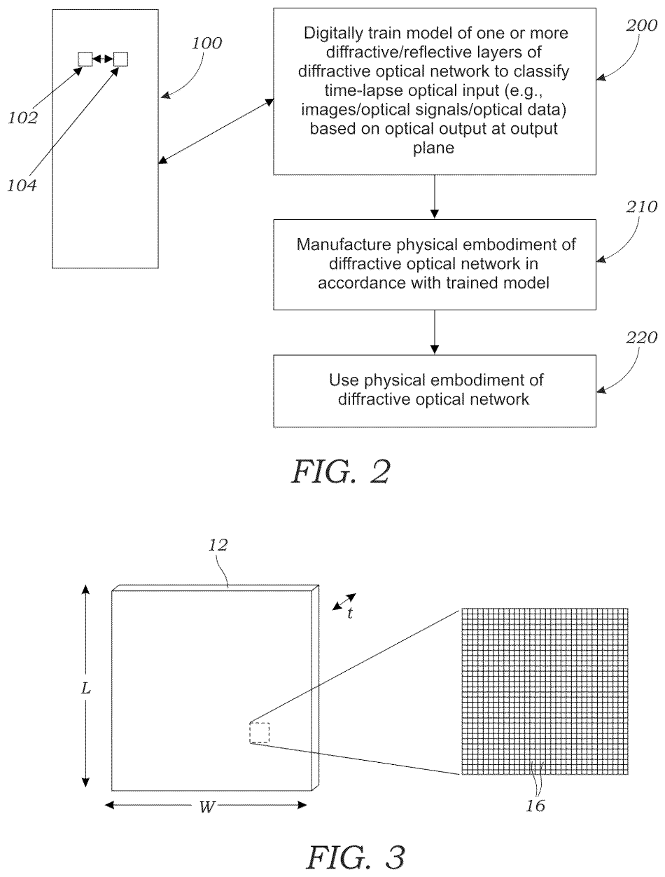

As explained herein, the design or physical embodiment of the diffractive optical network 10 is able to classify the optical input 24, e.g., time-lapse images, optical signals, or optical data. In some embodiments, the optical input 24 may pass through an aperture 25 prior to entering the diffractive layer(s) 12 as seen in FIG. 1. FIG. 2 illustrates a flowchart of the operations or processes according to one embodiment to create and use a diffractive optical network 10 for classifying an optical input 24 such as time-lapsed images, optical signals, or optical data. As seen in operation 200, at least one computing device 100 having one or more processors 102 executes software 104 thereon to then digitally train a model or mathematical representation of diffractive layer(s) 12 to classify the time-lapse images, signals, or data (e.g., optical input 24) that are input to the model of the diffractive optical network 10. In this digital training operation 200, a set of diffractive surfaces/layer(s) 12 are trained using deep learning to all-optically generate different optical outputs at an output plane 20) that correspond to the different classes of images, optical signals, or optical data that make up the optical input 24. Once the design or model has been established that encodes a physical layout for the different physical features 20 that form the artificial neurons in each of the plurality of diffractive layers 12 which are present in the diffractive optical network 10, the actual physical embodiment of the diffractive optical network 10 is then manufactured or fabricated that reflects the computer-derived design. This is illustrated in operation 210 of FIG. 2. The design, in some embodiments, may be embodied in a software format (e.g., SolidWorks. AutoCAD, Inventor, or other computer-aided design (CAD) program or lithographic software program) may then be manufactured into a physical embodiment that includes the diffractive layer(s) 12. The one or more layers 12, once manufactured may be mounted or disposed in a holder or housing 14 or housing as explained herein (e.g., FIG. 1). The holder or housing 14 may include a number of slots formed therein to hold the layers 12 in the required sequence and with the required spacing between adjacent layers 12 (if needed). Once the physical embodiment of the diffractive optical network 10 has been made, the diffractive optical network 10 is then used to perform the classification operation by inputting the optical input 14, namely, the time-lapse images, optical signals, or optical data to the layer(s) 12 of the diffractive optical network 10. The time-lapse output optical signals are captured by the optical detectors 22 which are used to classify the optical input 24 (e.g., time-lapse images/signals/optical data). Use of the physical embodiment is seen in operation 220 in FIG. 2.

### Results

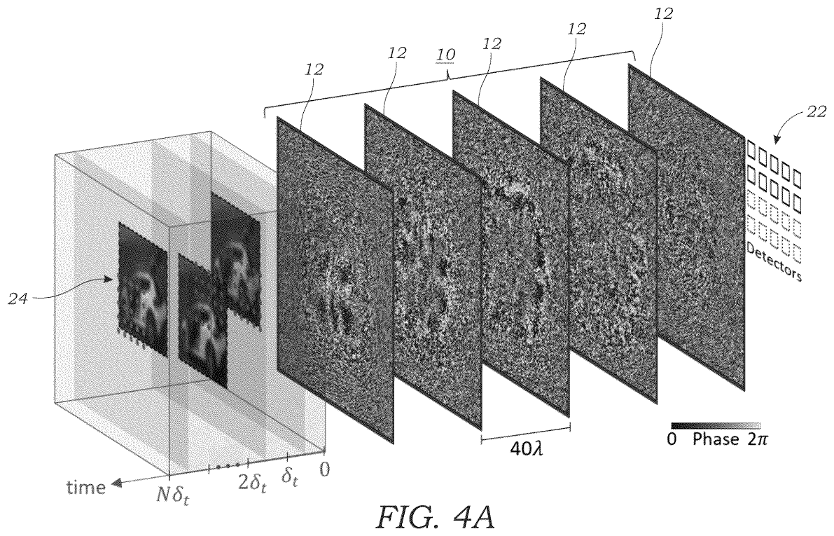

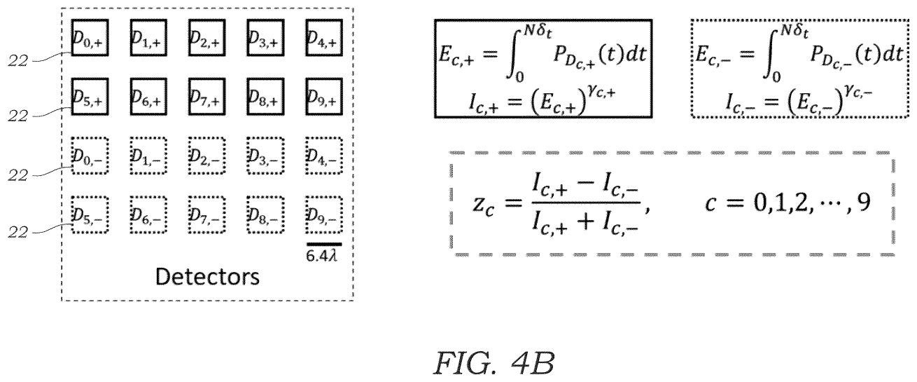

The concept of time-lapse image classification with a diffractive optical network 10 is illustrated in FIGS. 1A-1B and 4A and 4B. A diffractive optical network 10 including 5 phase-only diffractive layers 12 (FIG. 4A), axially separated by 401, is placed between the object plane and the detector or output plane 20. The detector or output plane 20 includes twenty (20) optical detectors 22 (FIG. 4B): two detectors for each data class c of the CIFAR-10 dataset, i.e., a ‘positive’ detector D_{c,+} and a ‘negative’ detector D_{c,-}. The integration time of the output detectors 22 is assumed to be Not, where N is the number of lateral object shifts and each of the N individual shifts has an equal integration time of δₜ. Without changing the conclusions, in alternative implementations, the diffractive optical network 10 can also laterally move relative to the static object, or both the object and the diffractive optical network 10 can laterally move at the same time. Each optical detector D_{c,±} is assigned an exponent γ_{c,±} which operates on the integrated detector power to yield the detector signal I_{c,±} (see FIG. 4B and the Methods section). Diffractive classification results are reported under two different conditions: (1) the exponents are assumed to be trainable, and (2) non-trainable, fixed as γ_{c,±}=1. The normalized differential class scores

$${z}_{c} = \frac{{I}_{c , +} - {I}_{c , -}}{{I}_{c , +} + {I}_{c , -}}$$

are calculated from these detector signals, and the prediction/inference is made in favor of the class receiving the highest differential optical score (see FIG. 4B).

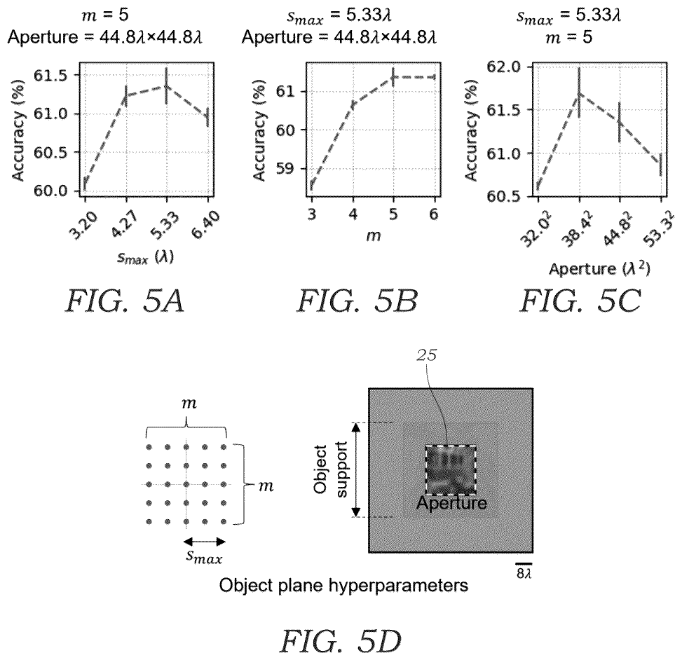

For all the D²NNs 10 reported herein, each trainable diffractive layer 12 consists of 200×200 diffractive elements (diffractive neurons) of size 0.53λ×0.53λ. The objects are assumed to be phase-only and the diffractive optical networks 10 are trained using the grayscale CIFAR-10 dataset (refer to the Methods section for details). The hyperparameters that define the grid of lateral displacements of the objects during the time-lapse image classification are sₘₐₓ and m, where sₘₐₓ is the maximum (relative) lateral displacement along x/y and m² refers to the total number of points on the grid, see FIG. 5D. The size of the input aperture 25 is another hyperparameter that affects the classification performance of the time-lapse diffractive optical networks 10. The impact of these hyperparameters, sₘₐₓ, m and the input aperture 25 size, on the performance of time-lapse diffractive classifiers is shown in FIGS. 5A-5C. The classification performance is quantified by the blind testing accuracy of the networks on 10,000 previously unseen images belonging to the test set of the CIFAR-10 dataset. To obtain each data point in FIGS. 5A-5C, three (3) different diffractive optical networks 10 were trained with the same hyperparameters and calculated the mean and standard deviation of blind testing accuracies of these three trained networks. One can see from FIG. 5A that as sₘₐₓ is increased from 3.20λ to 6.40λ (while keeping m=5 and the aperture size=44.8λ×44.8λ constant), the mean blind testing accuracy increases until sₘₐₓ=5.33λ, where it reaches its highest value of 61.35%. Beyond sₘₐₓ=5.33λ, the mean classification accuracy starts to decrease. In FIG. 5B, sₘₐₓ=5.33λ, aperture size=44.8λ×44.8λ and m is varied. As m is varied between 3 and 6, the mean accuracy increases rapidly from 58.56% to 61.35% until m=5, beyond which the mean accuracy reaches a plateau. For FIG. 5C, m=5 and sₘₐₓ=5.33λ (as optimized from FIGS. 5A-5B) and the width of the input aperture 25 was varied between 32.0λ and 53.3λ. The highest mean accuracy (FIG. 5C) is observed for an input aperture size of 38.4λ×38.4λ, which is smaller than the object support 44.8λ×44.8λ. This observation was compared with its counterpart for time-static diffractive image classification (see Table 1 below), where the aperture size corresponding to the highest mean blind testing accuracy is larger than the object support. This comparison indicates that a time-lapse diffractive optical network 10 prefers a relatively smaller input field-of-view compared to its time-static counterparts.

TABLE 1
Dependence of the performance of time-static diffractive
networks on the input-aperture size

| Aperture area | |
|---|---|
| (λ²) | Accuracy (%) |
| 38.4 × 38.4 | 50.80 ± 0.18 |
| 44.8 × 44.8 | 51.92 ± 0.29 |
| 51.2 × 51.2 | 52.76 ± 0.35 |
| 57.6 × 57.6 | 52.83 ± 0.13 |
| 64.0 × 64.0 | 52.76 ± 0.02 |
| 76.8 × 76.8 | 52.12 ± 0.17 |

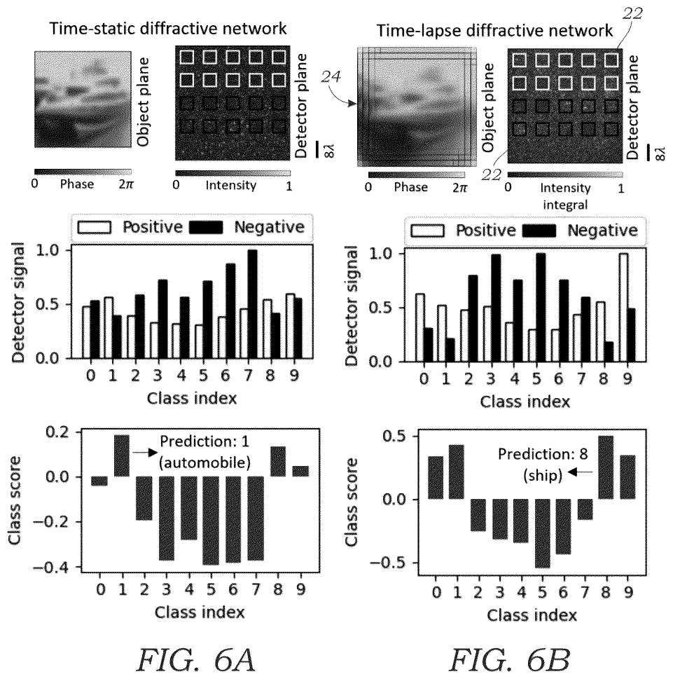

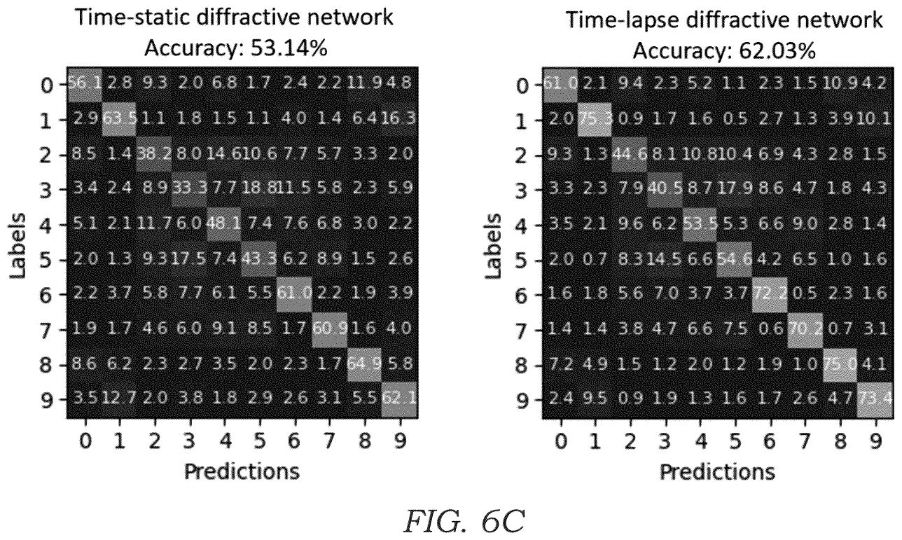

Next, a time-lapse image classification diffractive optical network 10 is juxtaposed with a time-static diffractive network: see FIGS. 6A-6C. For this comparison, the time-lapse diffractive optical network 10 with the best individual blind testing accuracy (62.03%) was chosen among the networks 10 constituting the results of FIGS. 6A-6C and the time-static diffractive optical network with the best individual blind testing accuracy (53.14%) among the networks constituting the results of Table 1. For the time-lapse image classification diffractive optical network 10, the hyperparameters corresponding to the highest individual accuracy were m=5, sₘₐₓ=5.33λ and input aperture size=38.4λ×38.4λ; while for the time-static network, the input aperture size corresponding to best individual accuracy was 51.2λ×51.2λ. Another difference to be noted between the time-static and the time-lapse diffractive optical networks 10 chosen for comparison in FIGS. 6A-6C is that for the time-static one, the detector exponents were not trainable, i.e., γ_{c,±}=1, whereas the detector exponents were trainable for the time-lapse network 10. The reason for this selection is that, unlike the time-lapse diffractive optical networks 10, time-static diffractive networks showed overfitting when the detector exponents are trainable, leading to inferior generalization; see Table 2.

TABLE 2
Dependence of the performance of time-static and time-lapse
diffractive networks on the trainability of γ_{c, ±}

| | Time-static* | Time-lapse** |
|---|---|---|
| γ_{c, ±} | 50.47 ± 0.90 | 61.69 ± 0.36 |
| (trainable) | | |
| γ_{c, ±} = 1 | 52.83 ± 0.13 | 60.27 ± 0.10 |
| (non-trainable) | | |

*Hyperparameter: Aperture = 57.6λ × 57.6λ
**Hyperparameters: sₘₐₓ = 5.33λ, m = 5, Aperture = 38.4λ × 38.4λ

For an example object from the image class ‘ship’ (true label: 8), FIG. 6A shows the detector plane intensity, detector signals and the class scores for the time-static network: similarly, in FIG. 6B the time-integral of the detector plane intensity, detector signals and the class scores are shown for the time-lapse image classification diffractive optical network 10. While the time-static network misclassifies the object for an ‘automobile’, the time-lapse image classification diffractive optical network 10 correctly predicts the object to be a ‘ship’ (predicted label: 8). FIG. 6C also shows the confusion matrices calculated over 10,000 test images of the CIFAR-10 dataset: the time-lapse image classification diffractive optical network 10 performs consistently better than the time-static one for all the CIFAR-10 data classes.

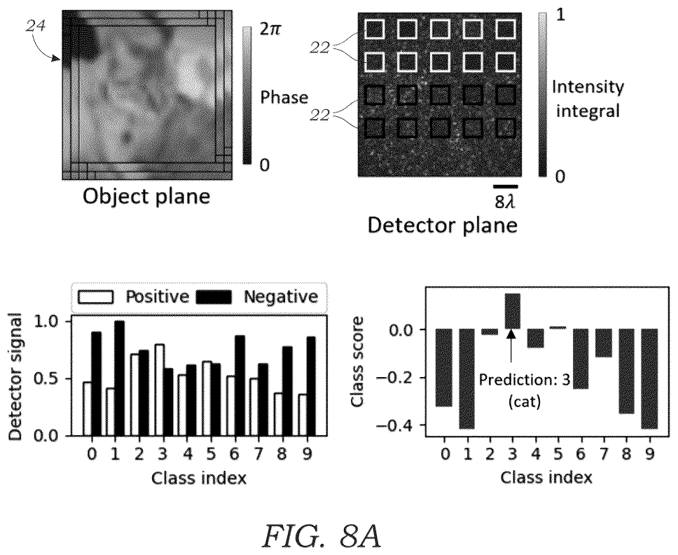

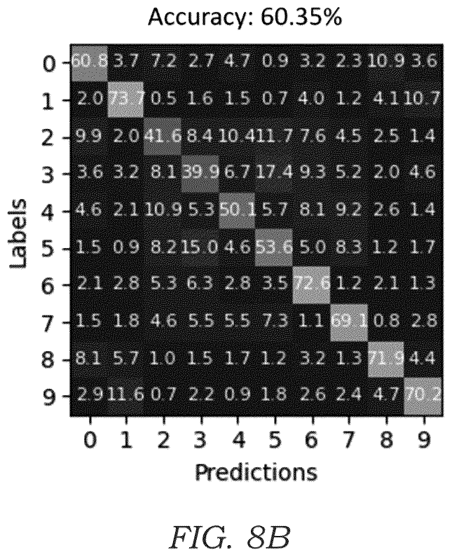

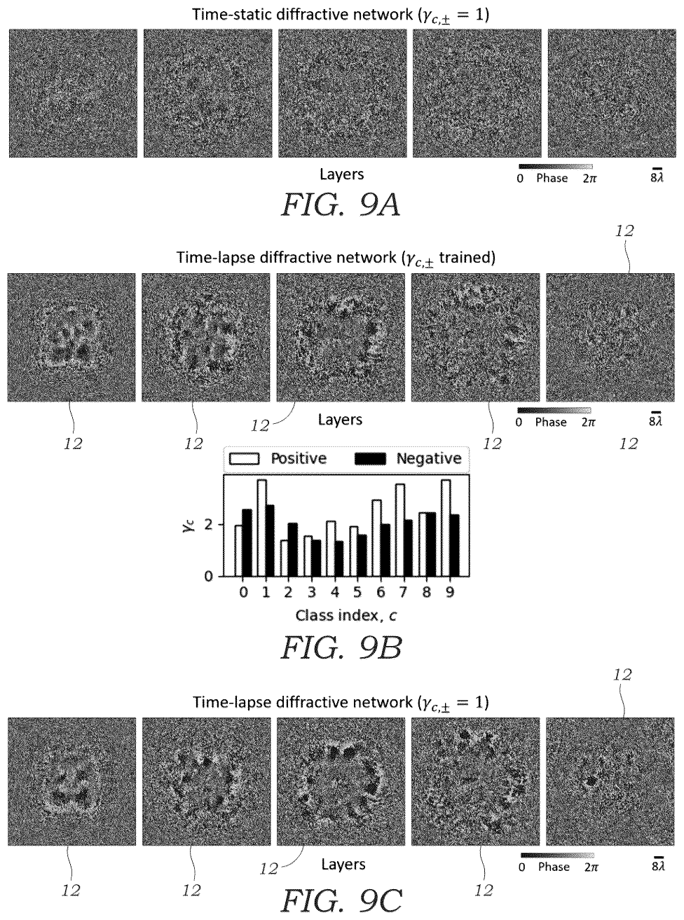

Note also that the time-lapse image classification diffractive optical network 10 designed with non-trainable detector exponents (i.e., γ_{c,±}=1) achieved a blind testing accuracy of 60.35% on the same grayscale CIFAR-10 test dataset (see FIGS. 8A-8B), performing much better than the time-static one for all the CIFAR-10 data classes. The diffractive layers 12 for all these networks are shown in FIGS. 9A-9C.

During the training of the time-lapse diffractive optical networks 10, a method similar to the ‘dropout’ method was followed, which is used in deep learning to reduce overfitting and improve the generalization of a trained model. A hyperparameter p was defined which is the probability that a point on the object-plane grid is ‘active’ during training, i.e., the probability that the object is positioned at that lateral point during the signal integration at the optical detector 22. All the time-lapse networks 10 described thus far were trained with p=0.5. As described below, the resilience of the trained time-lapse image classification diffractive optical networks 10 to deviations from the training settings can be improved by a proper choice of p, which is intuitively equivalent to the dropout strategy in deep learning literature.

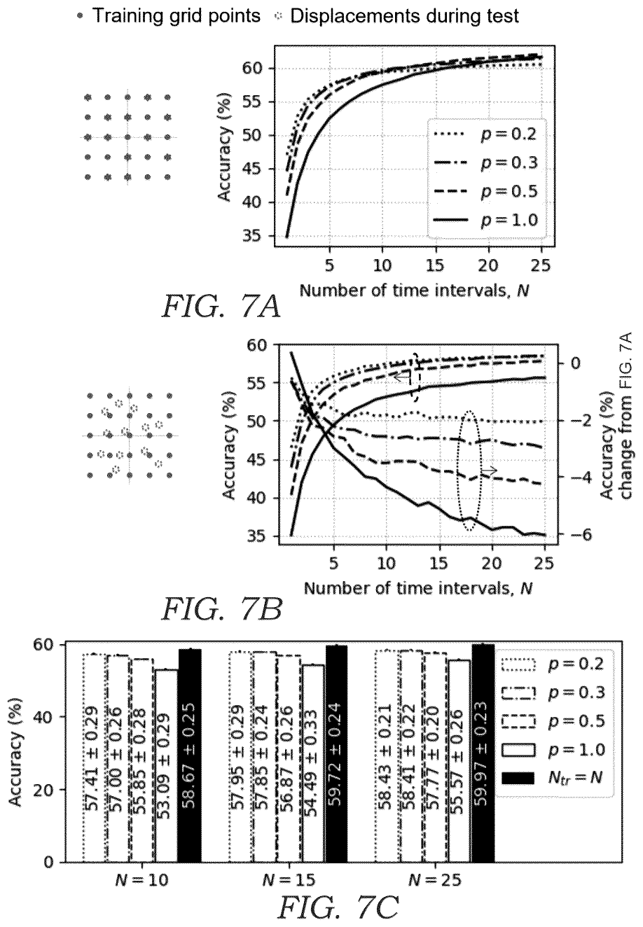

Related to this hyperparameter p, next, the impact of decreasing the number of lateral shifts, N, was explored on the blind testing accuracy of time-lapse networks 10: see FIGS. 7A-7C. The value for each data point in FIGS. 7A-7C represents the mean of the classification accuracies over 25 independent blind tests with the same N. For FIG. 7A, these N lateral displacements were restricted to coincide with the pre-determined training grid points, and for the case of N<m² m²−N of the m² lateral shifts were randomly eliminated (not used). For FIG. 7B, however, the N lateral displacements were randomly selected without following the training grid points. As one can see in FIG. 7A, the blind testing accuracy decreases as N is decreased: however, the slope of this performance degradation varies depending on the training hyperparameter p. For example, in the case of the time-lapse image classification diffractive optical network 10 shown in FIG. 9B, trained with p=0.5 (FIG. 7A), the test accuracy drops from 62.03% to 60.69% and 59.37% as N decreases from 25 to 15 and 10, respectively. Compare this with the case of a time-lapse diffractive optical network trained with p=1.0 (FIG. 4A), for which the classification accuracy is affected much more severely and decreases from 61.61% to 59.61% and 57.45% as N is decreased from 25 to 15 and 10, respectively. Diffractive optical networks 10 trained with lower p values show less sensitivity to decreasing N, which is further corroborated by the curves corresponding to two other time-lapse diffractive optical networks 10 trained with p=0.2 and p=0.3.

Another advantage of training with lower p values is decreased sensitivity to the exact object positions (see FIG. 7B). For FIG. 7B, the N lateral displacements without following the training grid points was selected, allowing the object to be displaced (during the time-lapse imaging process) to N arbitrary, randomly selected points within the area 2sₘₐₓ×2sₘₐₓ. In general, for a given N, the blind testing accuracies corresponding to such arbitrary displacements (left y-axis of FIG. 7B) are lower than their counterparts for the on-grid displacements shown in FIG. 7A. However, the degradation in classification accuracy, which is shown on the right y-axis of FIG. 7B, is much smaller when p is lower. For example, at N=25, the mean accuracy drop is ˜2% for the diffractive optical network 10 trained with p=0.2, whereas the accuracy drop is ˜6% for the p=1.0 diffractive optical network 10.

The accuracy of time-lapse diffractive network-based optical networks 10 for arbitrary lateral displacements of the input objects can be improved by utilizing such random displacements of the objects during the training, rather than training with a pre-determined grid of lateral displacements. For this, the training hyperparameters p and m can be absorbed into a single hyperparameter Nₜᵣ, where Nₜᵣ refers to the number of arbitrary displacements within 2sₘₐₓ×2sₘₐₓ. To demonstrate this, three time-lapse diffractive optical networks 10 were trained with Nₜᵣ=10, Nₜᵣ=15 and Nₜᵣ=25 and compared their accuracies for N=10, N=15, and N=25 arbitrary displacements of the input objects, respectively, against the classification accuracies of the time-lapse diffractive optical networks 10 reported in FIGS. 7A-7B. The result of this comparison is shown in FIG. 7C: for N=10, N=15 and N=25 arbitrary lateral displacements during the time-lapse imaging process, the mean blind testing accuracies of the corresponding Nₜᵣ=N diffractive optical networks 10 are 1.26%, 1.77%, and 1.54%, respectively, higher than the accuracies of the p=0.2 time-lapse diffractive optical network 10. This generalization improvement and the inference accuracy increase are due to using arbitrary random lateral displacements of the input objects during the training process instead of blindly applying such random lateral shifts only during the testing phase.

In previous work, Rahman, M. S. S., Li, J., Mengu, D., Rivenson, Y. & Ozcan, A. Ensemble learning of diffractive optical networks. Light Sci. Appl. 10, 14 (2021), which is incorporated by reference herein, a significant improvement in diffractive network inference performance was reported by ensemble learning and combining the output of several different diffractive networks. For example, mean blind testing accuracies of 61.14% and 62.13% on the CIFAR-10 test set were reported for ensembles of 14 and 30 different D²NNs, respectively. However, the improvement with such a strategy is accompanied by a sacrifice in the compactness of the optical hardware and increased complexity in aligning several diffractive networks within the ensemble. Another shortcoming of ensemble learning of diffractive networks is the large training time. In the previous work discussed above, 1252 diffractive models were trained, and ensemble pruning was then performed to arrive at the final design. Time-lapse diffractive network-based image classification provides blind testing accuracies comparable to ensemble learning with only a single trained diffractive optical network 10. For comparison, the time-lapse diffractive optical network 10 of FIG. 6B gives 62.03% blind testing accuracy on CIFAR-10 test images. The trade-off for such an advantage is the increase in the imaging/classification time due to the lateral shifts of the objects. However, the alignment and synchronization requirements associated with diffractive network ensembles are evaded. Also, the training of a time-lapse diffractive optical network 10 takes ˜20 hours on an NVIDIA Geforce RTX 3090 GPU (see the Methods section), which is orders of magnitude less than the time required to design an ensemble of diffractive networks working together.

Regarding the implementation of time-lapse diffractive network-based image classification, Spatial Light Modulators (SLMs) can be used to perform the lateral displacements of the optical input 24 (e.g., input objects) digitally if a digital representation of each object is available. In an alternative implementation, the diffractive layers 12 and the optical detectors 22 could be mounted on or coupled to a movable stage 26 to shift the entire system with respect to the object or input field-of-view. Perhaps, the simplest implementation of time-lapse diffractive optical network-based image classification would exploit the natural jitter or movement of the input objects during the integration time of the class optical detectors 22. As shown in FIG. 7C, ˜60% blind testing accuracy on CIFAR-10 test images can be reached with arbitrary object displacements during the time-lapse inference.

While time-lapse image classification significantly boosts the inference of a single D²NN on the classification of complex objects, there remains plenty of room for improvement to potentially close the large performance gap with their electronic counterparts, convolutional deep neural networks. One possible avenue for such an improvement could be the incorporation of ensemble learning with time-lapse image classification, where the outputs of diversely trained time-lapse D²NNs 10 could be combined for further improvement in generalization and statistical inference. Moreover, in the same way that the time-lapse scheme utilizes the complementary information resulting from the input objects that are laterally shifted, other attributes of light such as polarization or wavelength could also be utilized. For example, time-lapse diffractive optical networks 10 can be trained to work with RGB images instead of grayscale images to benefit from the complementary information carried by different color channels. The incorporation of optical nonlinearities between the diffractive layers 12 of D²NNs 10 could also extend their approximation capability and consequently improve their statistical inference. All of these constitute possible future directions to explore for further decreasing the performance gap between electronic deep neural networks and D²NNs 10.

In summary, a time-lapse diffractive optical network 10 is described for image use in a classification scheme for significantly improving the performance of D²NN classifiers with only a single trained diffractive optical network 10. The presented time-lapse diffractive optical network 10 could be vital for realizing compact, low-cost and passive optical processors for all-optical spatio-temporal analysis of information.

### Materials and Methods

Forward model. The propagation of coherent light across K+2 parallel planes defined by the input (object) plane, K successive diffractive layers, and the output (optical detector(s)) plane is modeled using the Rayleigh-Sommerfeld theory of scalar diffraction, according to which the propagation of a complex wave U(x, y) through a distance z in free-space is described by a linear shift-invariant system with an impulse response defined as follows:

$$h ( x , y ; z ) = \frac{z}{{r}^{2}} ( \frac{1}{2 π r} + \frac{1}{j λ} ) exp ( j \frac{2 π r}{λ} )$$

where λ is the illumination wavelength, r=\sqrt{x²+y²+z²} and j=\sqrt{−1}. Upon propagation through the free-space separating layer l−1 and layer l, the complex field is modulated by the spatially varying complex transmittance tₗ(x, y) of layer l, i.e.:

$$U ( x , y ; {z}_{l} ) = {t}_{l} ( x , y ) \int \int h ( x - {x}^{′} , y - {y}^{′} ; {z}_{l} - {z}_{l - 1} ) U ( {x}^{′} , {y}^{′} ; {z}_{l - 1} ) {dx}^{′} {dy}^{′}$$

$${t}_{l} ( x , y ) = {a}_{l} ( x , y ) exp ( j {φ}_{l} ( x , y ) )$$

Here, zₗ is the axial coordinate of the l-th plane, and l=1, . . . , K, whereas aₗ(x, y) and φₗ(x, y) are the amplitude and the phase of the complex field transmittance tₗ(x, y). For the phase-only diffractive networks reported herein, aₗ(x, y) is assumed to be 1.

In a differential classification scheme, each of the ten (10) classes of the CIFAR-10 dataset is assigned to two detectors: a virtual positive detector and a virtual negative detector. D_{c.+} (D_{c,-}) denotes the active area of the positive (negative) detector assigned to class c, c=0, 1, . . . , 9. For the time-static diffractive networks, the detector signals I_{c,±}, based on which the class scores are computed, are proportional to the detector powers P_{c,±}, where

$${P}_{c , \pm } = \int {\int }_{{D}_{c , \pm }} {\vert U ( x , y ; {z}_{K + 1} ) \vert}^{2} dxdy$$

For the time-lapse diffractive network, light is assumed to be integrated at the detectors over N intervals of δₜ duration each. The object function (0) during the n-th interval can be expressed as:

$${O}_{n} ( x , y ) = O ( x - {x}_{n} , y - {y}_{n} )$$

$$n = 1 , … , N$$

$$( {x}_{n} , {y}_{n} ) ∈ X \times Y$$

$$X = Y = linspace ( - {s}_{max} , {s}_{max} , m )$$

where linspace(−sₘₐₓ, sₘₐₓ, m) denotes the set of m linearly spaced values between −sₘₐₓ and sₘₐₓ. Accordingly, the optoelectronic signals at the detectors are proportional to the integrated photon signals

$${E}_{c , \pm } = α {\int }_{0}^{N {δ}_{t}} {P}_{{D}_{c , \pm }} ( t ) dt$$

Here, α is an optoelectronic detector-specific constant, and it assumes that the propagation delay of light between the object plane and the detector plane is negligible compared to dt.

The detectors are assigned the exponents γ_{c,±}, which operate on the optoelectronic signals E_{c,±} (after E_{c,±} are normalized to have a maximum value of 1) and generate the detector signals I_{c,±}:

$${I}_{c , \pm } = {( {E}_{c , \pm } )}^{{γ}_{c , \pm }}$$

Finally, the differential class scores are calculated as:

$${z}_{c} = \frac{{I}_{c , +} - {I}_{c , -}}{{I}_{c , +} + {I}_{c , -}}$$

and the prediction for the object class is defined to be arg max z_{c}.

Numerical implementation. When numerically modeling light propagation through the diffractive optical networks 10, the grid spacing along the transverse directions (x and y) was chosen to be ˜0.531. The Rayleigh-Sommerfeld convolution integrals were computed using the Angular Spectrum Method based on the Fast Fourier Transform (FFT). For all the results presented herein, the diffractive optical networks 10 consisted of 5 phase-only diffractive layers 12, axially separated by 40λ. Each layer 12 comprised 200×200 diffractive features/neurons, the phases of which were trainable. The (physical) size of each diffractive neuron was assumed to be ˜0.53λ×0.53λ.

The RGB images in the CIFAR-10 dataset were converted to grayscale to represent the input objects illuminated by a monochromatic and spatially-coherent wave. The objects were resized to span an area of 44.8λ×44.8λ. The object information was assumed to be encoded in the phase channel of the input light, i.e., within the input field of view,

$$U ( x , y ; {z}_{0} ) = exp ( j2 π O ( x , y ) )$$

where O(x, y) is the object function, with its values normalized to lie between 0 and 1. On the output plane 20, the active area of each optical detector 22 was assumed to be 6.4λ×6.4λ, and the spacing between the optical detectors 22 was ˜4.27 along both x and y directions (see FIGS. 1A-1B).

Training. The digital diffractive optical networks were trained using the cross-entropy loss function. The differential class-scores

$${\{ {z}_{c} \}}_{c = 0}^{9}$$

were converted to probabilities

$${\{ {q}_{c} \}}_{c = 0}^{9}$$

over the classes using the softmax function, i.e.,

$${q}_{c} = \frac{exp ( β {z}_{c} )}{{\sum }_{i} exp ( β {z}_{i} )}$$

where β=10 was used. The training loss was defined as:

$$ℒ = - {\sum }_{c = 0}^{9} {δ}_{c k} log {q}_{c}$$

where k is the (true) label, and δ_{ck} is the Kronecker delta function, i.e., δ_{ck}=1 if c=k and 0 otherwise.

The trainable parameters of the model were trained by minimizing the loss [symbol] using the Adaptive Momentum (‘Adam’) stochastic gradient descent algorithm. The forward model was implemented using the open-source deep learning library TensorFlow. The automatic differentiation functionality of TensorFlow was exploited to facilitate the gradient computations for optimization. A batch size of 8 was used to implement the stochastic gradient descent. The built-in TensorFlow implementation of Adam optimizer was used with the default values except for the learning rate, which had an initial value of 0.001 and was reduced by a factor of 0.7 every 8 epochs.

All the networks were trained for 100 epochs using 45000 images from the training set of the CIFAR-10 dataset. The remaining 5000 images of the CIFAR-10 training set were left out for validation, i.e., after every epoch, the accuracy of the model on these 5000 images was evaluated. The model state at the end of the epoch for which the validation accuracy was maximum was ultimately used for blind testing.

The training time of the time-lapse diffractive optical networks 10 depended upon the hyperparameters m and p. For m=5 and p=0.5, the training took ˜20 hours on an NVIDIA Geforce RTX 3090 GPU in a machine running on Windows 10.

While embodiments of the present invention have been shown and described, various modifications may be made without departing from the scope of the present invention. For example, while the diffractive optical networks 10 have been largely described in the context of transmissive layers 12 it should be appreciated that the diffractive optical network 10 may also include reflective layers 12 (or combinations of transmissive and reflective layers). The invention, therefore, should not be limited, except to the following claims, and their equivalents.

1. A diffractive optical network for classifying time-lapse input images, input optical signals, or input optical data comprising:
a plurality of optically transmissive and/or reflective layers arranged in one or more optical paths, each of the plurality of optically transmissive and/or reflective layers comprising a plurality of physical features located in different locations in each of the one or more layers of the network and having different valued transmission and/or reflection parameters as a function of lateral coordinates across each layer, wherein the plurality of optically transmissive and/or reflective layers and the plurality of physical features collectively generate different optical outputs at an output plane for different classes of input images, input optical signals, or input optical data;
a plurality of optical detectors disposed along the one or more optical paths and located at the output plane and positioned to capture the different optical outputs of the diffractive optical network; and
wherein relative movement between the (1) input images, input optical signals, or input optical data and the (2) diffractive optical network generates a time-lapse optical output at the output plane that is captured by the plurality of optical detectors and is used to classify the input images, input optical signals, or input optical data.

2. The diffractive optical network of claim 1, further comprising one or more spatial light modulators (SLMs) that provide relative movement between the (1) input images, input optical signals, or input optical data and the (2) diffractive optical network.

3. The diffractive optical network of claim 1, further comprising a moveable stage mounted or coupled to the diffractive optical network and the plurality of optical detectors.

4. The diffractive optical network of claim 1, wherein the relative movement is provided by natural jitter or movement of the input images, input optical signals, input optical data, or the diffractive optical network.

5. The diffractive optical network of claim 1, further comprising an aperture interposed between the input images, input optical signals, or input optical data and the diffractive optical network.

6. The diffractive optical network of any of claim 1, wherein a pair of detectors is provided for each data class to capture virtual positive and negative output optical signals in order to classify the input images, input optical signals, or input optical data.

7. The diffractive optical network of claim 1, wherein the plurality of optically transmissive and/or reflective layers comprise optical nonlinearities.

8. The diffractive optical network of claim 1, wherein one or more layers of the diffractive optical network comprise reconfigurable spatial light modulator(s).

9. A method of classifying time-lapse input images, input optical signals, or input optical data comprising:
providing a diffractive optical network comprising:
a plurality of optically transmissive and/or reflective layers arranged in one or more optical paths, each of the plurality of optically transmissive and/or reflective layers comprising a plurality of physical features located in different locations in each of the one or more layers of the network and having different valued transmission and/or reflection parameters as a function of lateral coordinates across each layer, the plurality of physical features being fabricated following a trained electronic model of the diffractive optical network, wherein the plurality of optically transmissive and/or reflective layers and the plurality of physical features collectively generate different optical outputs at an output plane for different classes of input images, input optical signals, or input optical data;
a plurality of optical detectors disposed along the one or more optical paths and located at the output plane and positioned to capture the different optical outputs of the diffractive optical network; and
inputting the input images, input optical signals, or input optical data to the diffractive optical network while there is relative movement between the (1) input images, input optical signals, or input optical data and the (2) diffractive optical network and generating a time-lapse optical output at the output plane that is captured by the plurality of optical detectors and is used to classify the input images, input optical signals, or input optical data.

10. The method of claim 9, wherein one or more spatial light modulators (SLMs) provide relative movement between the (1) input images, input optical signals, or input optical data and the (2) diffractive optical network.

11. The method of claim 9, wherein the diffractive optical network further comprises a moveable stage mounted or coupled to the diffractive optical network and the plurality of optical detectors.

12. The method of claim 9, wherein the relative movement is provided by natural jitter or movement of the input images, input optical signals, input optical data, or the diffractive optical network.

13. The method of claim 9, further comprising an aperture interposed between the input images, input optical signals, or input optical data and the diffractive optical network.

14. The method of claim 9, wherein a pair of detectors is provided for each data class to capture virtual positive and negative output optical signals in order to classify the input images, input optical signals, or input optical data.

15. The method of claim 9, wherein the plurality of optically transmissive and/or reflective layers comprise optical nonlinearities.

16. The method of claim 9, wherein one or more layers of the diffractive optical network comprise reconfigurable spatial light modulator(s).

17. The method of claim 9, wherein the time-lapse optical output comprises a time scale of ≤10 sec.
